(19) United States
(12) Patent Application Publication
(10) Pub. No.: US 2015/0346481 A1
(43) Pub. Date: Dec. 3, 2015

(54) OPTICAL DEFLECTOR AND IMAGE FORMING APPARATUS INCLUDING THE SAME

(71) Applicant: KYOCERA Document Solutions Inc., Osaka (JP)

(72) Inventor: Yuji TOYOTA, Osaka (JP)

(21) Appl. No.: 14/721,074

(22) Filed: May 26, 2015

(30) Foreign Application Priority Data
May 28, 2014 (JP) 2014-109755

(51) Int. Cl. G02B 26/08

(52) U.S. Cl. CPC G02B 26/0841; G03G 15/04

(57) ABSTRACT

In an optical deflector, a vibration mirror part extends in a direction crossing a swing axis of the vibration mirror part. A rib part extending along an extension direction of the vibration mirror part is formed on an opposite side surface of the reflective surface side in the vibration mirror part. The optical deflector further includes a solidified portion. The solidified portion is provided adjacent to both end portions of the rib part in the extension direction. The solidified portion is obtained by solidifying a liquid or gel-like substance in a state in which the surface of the liquid or gel-like substance has a curved surface shape by surface tension.

### CROSS-REFERENCE TO RELATED APPLICATION

This application is based upon and claims the benefit of priority from Japanese Patent Application No. 2014-109755 filed on May 28, 2014, the entire contents of which are incorporated herein by reference.

### BACKGROUND

The present invention relates to an optical deflector and an image forming apparatus including the same.

Conventionally, there has been known a resonance type optical deflector including a vibration mirror part and a torsion bar part that supports the vibration mirror part. In this optical deflector, when the vibration mirror part vibrates, airflow generated around the vibration mirror part may be separated from an end edge of the vibration mirror part and may allow the behavior (amplitude) of the vibration mirror part to be unstable. In this regard, there has been proposed to attach a rectifying member for adjusting the flow of air to a surface of the vibration mirror part opposite to a reflective surface side of the vibration mirror part. The rectifying member has a semi-cylindrical shape and is configured to suppress the separation of the airflow generated around the vibration mirror part.

### SUMMARY

An optical deflector according to one aspect of the present disclosure includes a vibration mirror part having a reflective surface for reflecting light, a torsion bar part that supports the vibration mirror part, and a driving part that torsionally vibrates the vibration mirror part around the torsion bar part.

The vibration mirror part extends in a direction crossing a swing axis of the vibration mirror part. A rib part extending along an extension direction of the vibration mirror part is formed on an opposite side surface of the reflective surface side in the vibration mirror part. Furthermore, the optical deflector further includes a solidified portion. The solidified portion is provided adjacent to both end portions of the rib part in an extension direction. The solidified portion is obtained by solidifying a liquid or gel-like substance in a state in which the surface of the liquid or gel-like substance has a curved surface shape by surface tension.

An image forming apparatus according to another aspect of the present disclosure includes the optical deflector.

### BRIEF DESCRIPTION OF THE DRAWINGS

FIG. 1 is a schematic sectional view illustrating an image forming apparatus including an optical deflector in the present embodiment.

FIG. 2 is a plan view illustrating an optical scanning device including an optical deflector in the present embodiment when viewed from the fore side.

FIG. 3 is a plan view illustrating an optical deflector in the present embodiment when viewed from the back side.

FIG. 4 is a sectional view taken along line IV-IV of FIG. 2.

FIG. 5 is a sectional view taken along line V-V of FIG. 2.

FIG. 6 is a plan view illustrating a vibration mirror part when viewed from a side opposite to a reflective surface side.

FIG. 7 is a view viewed in the arrow direction of VII of FIG. 6.

FIG. 8 is a view viewed in the arrow direction of VIII of FIG. 6.

FIG. 9 is a view corresponding to FIG. 3, which illustrates another embodiment.

FIG. 10 is a view corresponding to FIG. 3, which illustrates another embodiment.

FIG. 11 is a view corresponding to FIG. 3, which illustrates another embodiment.

### DETAILED DESCRIPTION

Hereinafter, embodiments of the technology of the present disclosure will now be described in detail with reference to the drawings. The technology of the present disclosure is not limited to the following embodiments.

### Embodiment 1

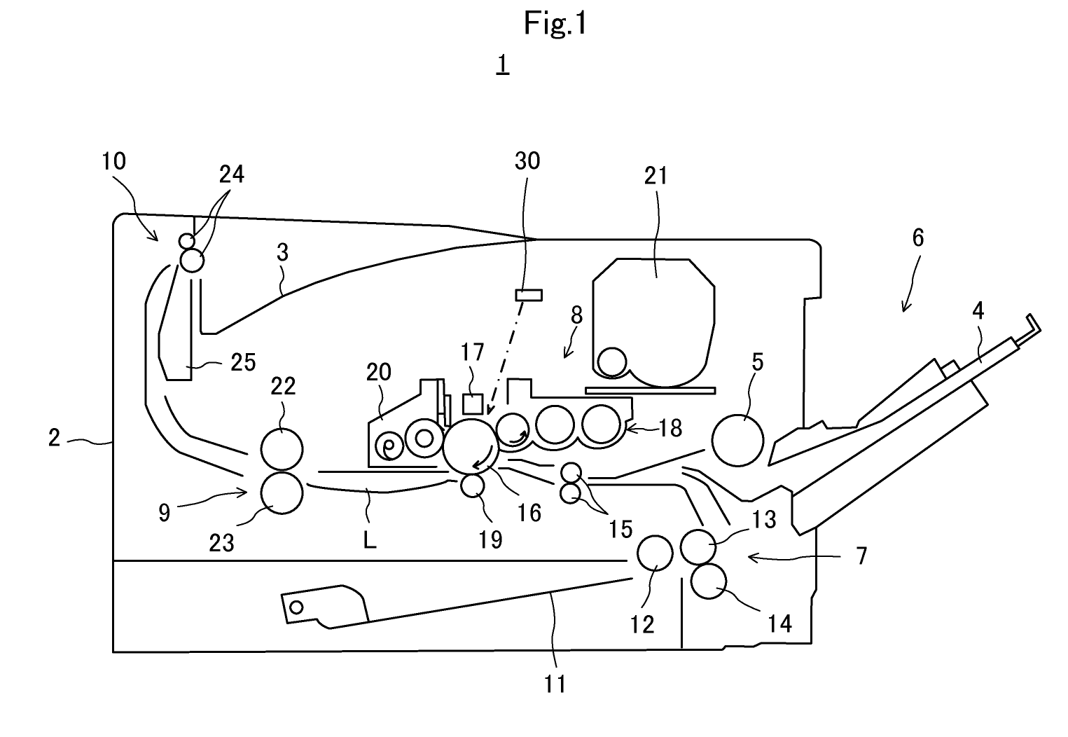

FIG. 1 is a sectional view illustrating a schematic configuration of a laser printer 1 as an image forming apparatus in the present embodiment.

As illustrated in FIG. 1, the laser printer 1 includes a box-like printer body 2, a manual paper feeding unit 6, a cassette paper feeding unit 7, an image forming unit 8, a fixing unit 9, and a paper discharge unit 10. Accordingly, the laser printer 1 is configured to form an image on a paper on the basis of image data transmitted from a terminal and the like (not illustrated) while conveying the paper along a conveyance path L in the printer body 2.

The manual paper feeding unit 6 has a manual tray 4 provided at one side portion of the printer body 2 so as to be openable and closable, and a manual paper feeding roller 5 rotatably provided inside the printer body 2.

The cassette paper feeding unit 7 is provided at a bottom portion of the printer body 2. The cassette paper feeding unit has a paper feeding cassette 11 that accommodates a plurality of papers stacked each other, a picking roller 12 that takes out the papers in the paper feeding cassette 11 one by one, and a feed roller 13 and a retard roller 14 that separate the taken-out papers one by one and send the separated paper to the conveyance path L.

The image forming unit 8 is provided above the cassette paper feeding unit 7 in the printer body 2. The image forming unit 8 includes a photosensitive drum 16 serving as an image carrying member rotatably provided in the printer body 2, and a charging device 17, a developing unit 18, a transfer roller 19, a cleaning unit 20 which are disposed in the vicinity of the photosensitive drum 16, an optical scanning device 30 disposed above the photosensitive drum 16, and a toner hopper 21. Accordingly, the image forming unit 8 is configured to form an image on a paper supplied from the manual paper feeding unit 6 or the cassette paper feeding unit 7.

The conveyance path L is provided with a pair of resist rollers 15 that allow fed out papers to be temporarily waiting and then supply the papers to the image forming unit 8 at a predetermined timing.

The fixing unit 9 is disposed at a lateral side of the image forming unit 8. The fixing unit 9 includes a fixing roller 22 and a pressing roller 23 brought into press-contact with each other and rotating together with each other. Accordingly, the fixing unit 9 is configured to fix a toner image, which has been transferred to a paper in the image forming unit 8, to the paper. The paper discharge unit 10 is disposed above the fixing unit 9. The paper discharge unit 10 includes a paper discharge tray 3, a pair of paper discharge rollers 24 for conveying a paper to the paper discharge tray 3, and a plurality of conveyance guide rib parts 25 for guiding the paper to the paper discharge roller pair 24. The paper discharge tray 3 is formed in a concave shape at an upper portion of the printer body 2.

When the laser printer 1 receives image data, the photosensitive drum 16 is rotationally driven and the charging device 17 electrifies the surface of the photosensitive drum 16 in the image forming unit 8.

Next, on the basis of the image data, laser light is emitted to the photosensitive drum 16 from the optical scanning device 30. The laser light is irradiated onto the surface of the photosensitive drum 16, so that an electrostatic latent image is formed. The electrostatic latent image formed on the photosensitive drum 16 is developed in the developing unit 18, so that the electrostatic latent image becomes a visible image as a toner image.

Then, the paper is pushed to the surface of the photosensitive drum 16 by the transfer roller 19. In this way, the toner image of the photosensitive drum 16 is transferred to the paper. The paper with the transferred tone image is heated and pressed by the fixing roller 22 and the pressing roller 23 in the fixing unit 9. As a consequence, the toner image is fixed to the paper.

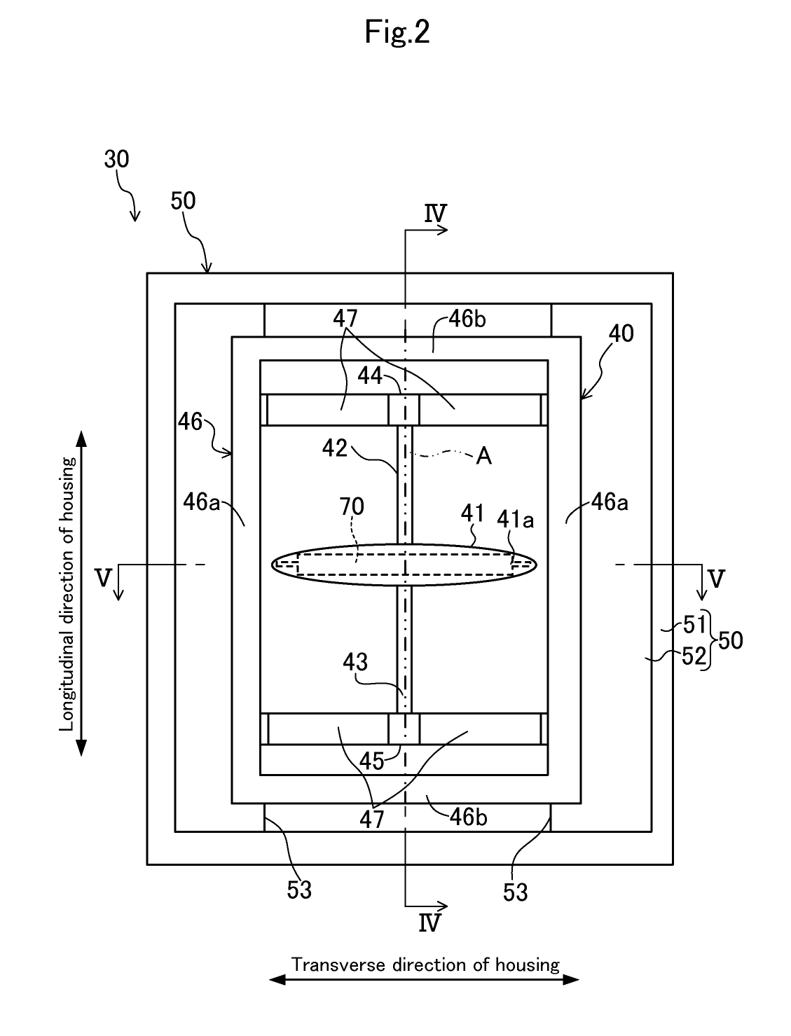

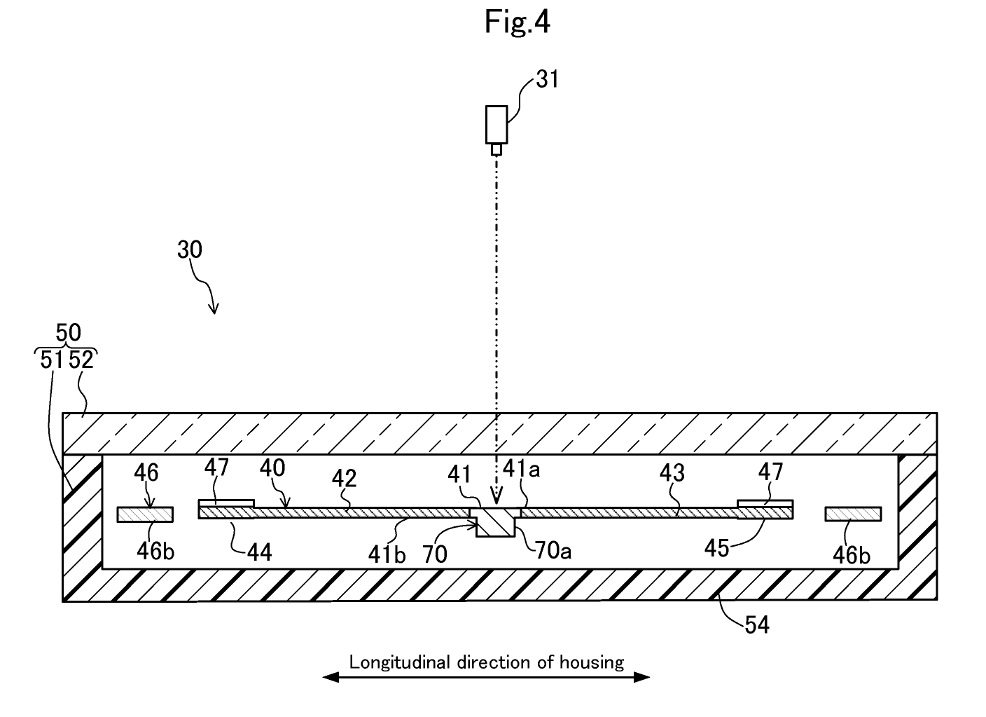

As illustrated in FIG. 2 to FIG. 5, the optical scanning device 30 has a light source 31 (illustrated only in FIG. 4) that emits light, a deflector 40, and a housing 50 that accommodates the deflector 40.

The housing 50 is formed in an approximately rectangular parallelepiped shape in a whole view. When viewed from a plan view, the housing 50 has a rectangular shape in which a length in a longitudinal direction (an up and down direction of FIG. 2) is larger than that in a transverse direction (a right and left direction of FIG. 2). The housing 50 has a bottomed housing body 51 with an opened one side (a front side of the paper surface of FIG. 2) in a height direction, and a lid 52 that closes the opened side of the housing body 51. The housing body 51, for example, is made of a resin material, and the lid 52 is made of a transmittive member, for example, glass. The lid 52 is configured to allow both light incident into a vibration mirror part 41 to be described later from the light source 31 and light reflected by the vibration mirror part 41 to pass therethrough.

The aforementioned deflector 40 is a so-called MEMS (Micro Electro Mechanical System) device, and is formed by etching a silicon plate.

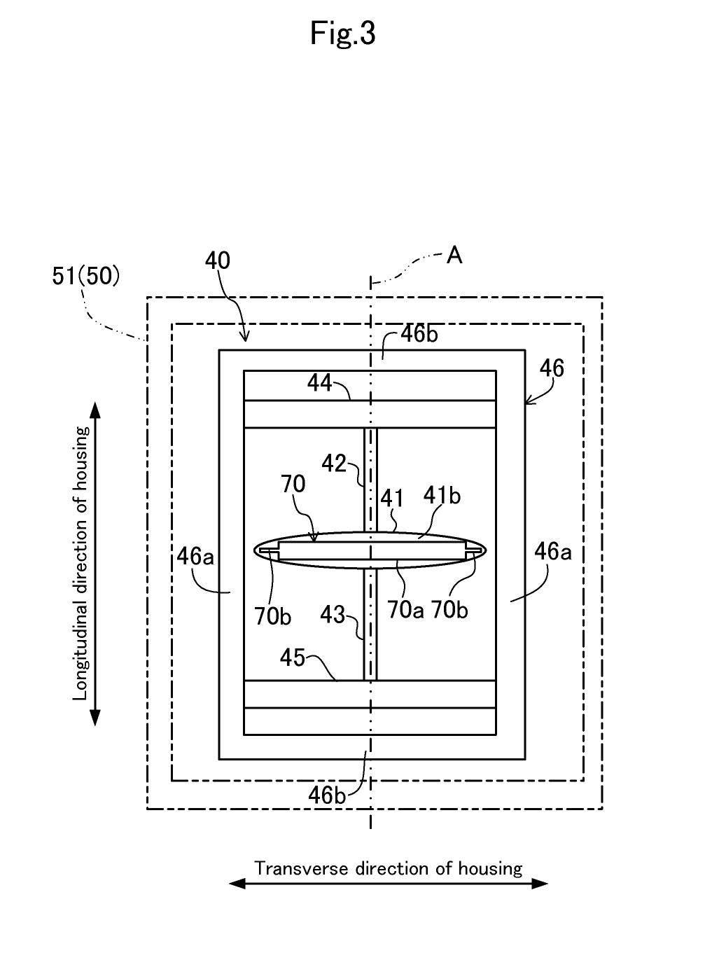

In detail, as illustrated in FIG. 3, the deflector 40 has the vibration mirror part 41, first and second torsion bar parts 42 and 43, first and second horizontal beam parts 44 and 45, and a fixed frame part 46 having an approximately rectangular plate shape. The vibration mirror part 41 is formed in a thin plate shape having an approximately oval shape when viewed from a plan view. The vibration mirror part 41 is disposed at an approximately center of the fixed frame part 46. A long diameter direction of the vibration mirror part 41 coincides with a transverse direction of the housing and a short diameter direction (a swing axis direction) of the vibration mirror part 41 coincides with a longitudinal direction of the housing. One side surface (a surface of a front side toward the paper surface of FIG. 2) of the vibration mirror part 41 in a thickness direction serves as a reflective surface 41a for reflecting light emitted from the light source 31 (see FIG. 4). The reflective surface 41a is formed with a light reflective film made of, for example, aluminum or chrome in order to enhance light reflectance. The vibration mirror part 41 torsionally vibrates around the aforementioned both torsion bar parts 42 and 43, thereby changing a reflective direction of light incident into the reflective surface 41a from the light source 31 and thus reciprocally scanning the light in a predetermined direction.

The aforementioned the first and second torsion bar parts 42 and 43 have a long plate shape in the longitudinal direction of the housing. Both the first and second torsion bar parts 42 and 43 are disposed on an extension line (on an extension line of a short axis) of a swing axis A of the vibration mirror part 41 in a plan view. The first torsion bar part 42 has one end portion connected to the center part of the vibration mirror part 41 in the long diameter direction and the other end portion connected to the center part of the first horizontal beam part 44 in the longitudinal direction. The second torsion bar part 43 has one end portion connected to the center part of the vibration mirror part 41 in the long diameter direction and the other end portion connected to the center part of the second horizontal beam part 45 in the longitudinal direction. Accordingly, both torsion bar parts 42 and 43 support the vibration mirror part 41 such that the vibration mirror part 41 can swing (vibrate) around the swing axis A.

The first horizontal beam part 44 and the second horizontal beam part 45 are disposed with an interval in the longitudinal direction of the housing. The vibration mirror part 41 is disposed between both horizontal beam parts 44 and 45. Both end portions of the first horizontal beam part 44 and both end portions of the second horizontal beam part 45 are connected to the fixed frame part 46. The fixed frame part 46 has a pair of longitudinal side portions 46a extending in the longitudinal direction of the housing and a pair of transverse side portions 46b extending in the transverse direction of the housing. The aforementioned first and second horizontal beam parts 44 and 45 are respectively disposed across between both longitudinal side portions 46a of the fixed frame part 46. Each of the first and second horizontal beam parts 44 and 45 is provided with two piezoelectric elements 47 (see FIG. 2 and FIG. 4) serving as driving parts. Each piezoelectric element is electrically connected to a driving circuit (not illustrated). Furthermore, an applied voltage applied to each piezoelectric element 47 is changed to a predetermined frequency by the driving circuit, so that each piezoelectric element 47 is extended and retracted for vibration. A vibration frequency of each piezoelectric element 47 is set to coincide with a resonance frequency of the vibration mirror part 41. The resonance frequency, for example, is changed by various factors such as the moment of inertia of the vibration mirror part 41, the mass of the vibration mirror part 41, and spring constants of the torsion bar parts 42 and 43. When the piezoelectric elements 47 vibrate with the aforementioned resonance frequency, the vibration mirror part 41 resonates and torsionally vibrates around both torsion bar parts 42 and 43.

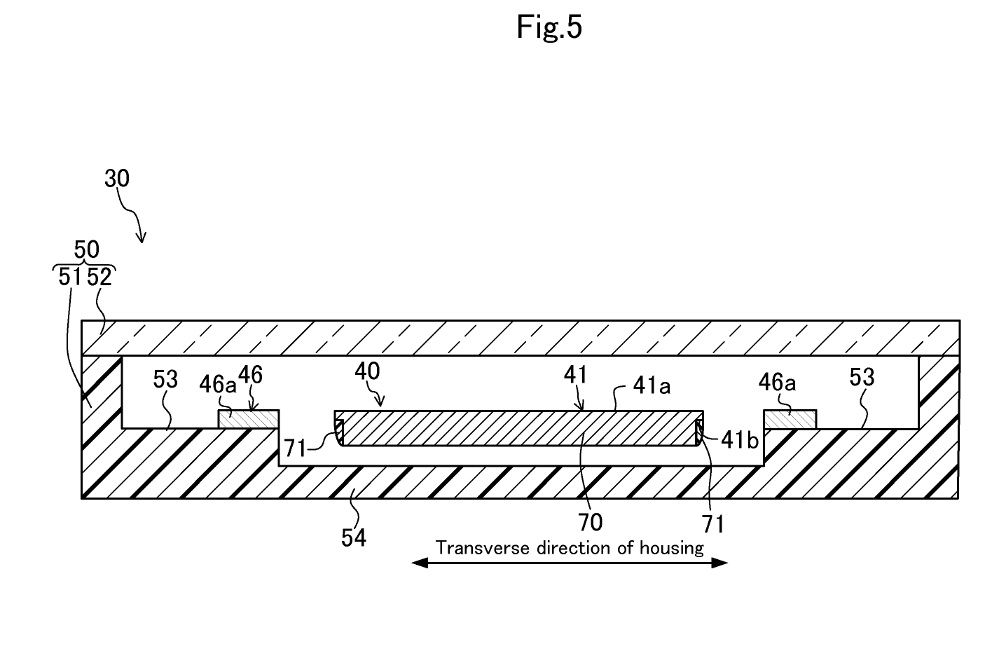

The aforementioned fixed frame part 46 is supported by a pair of pedestal parts 53 (see FIG. 5) formed in the housing body 51. The pair of pedestal parts 53 include stepped portions formed at both end portions of lower wall portions 54 of the housing body 51 in the transverse direction of the housing. The pair of pedestal parts 53 are formed over the entire housing body 51 in the longitudinal direction. The aforementioned fixed frame part 46 is disposed across between the pair of pedestal parts 53.

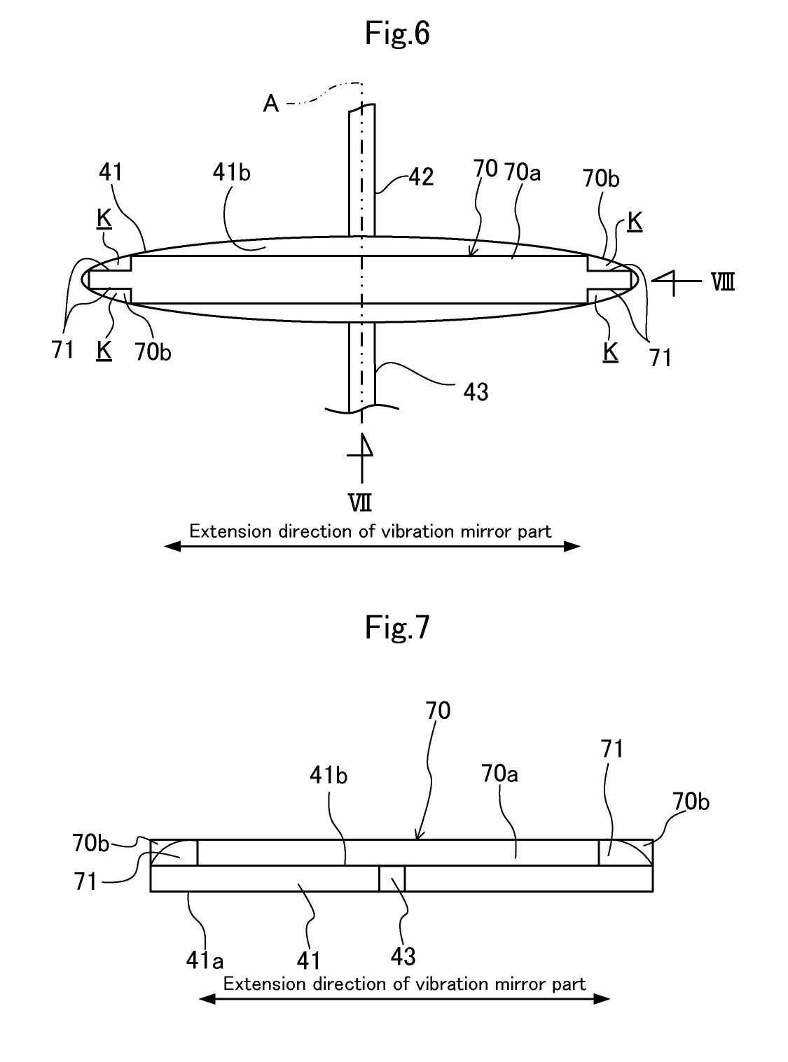

As illustrated in FIG. 6 and FIG. 7, a rib part 70 is formed on an opposite side surface 41b of the aforementioned reflective surface 41a in the aforementioned vibration mirror part 41. The rib part 70 extends along an extension direction (a direction perpendicular to the swing axis A) of the vibration mirror part 41. The rib part 70 includes a columnar portion having a height in the vertical direction of the aforementioned opposite side surface 41b in the vibration mirror part 41. The rib part 70 has a wide portion 70a and a pair of narrow portions 70b. The wide portion 70a extends across the swing axis A to be in line symmetry with respect to the swing axis A. The narrow portions 70b extend around the end portion of the vibration mirror part 41 in the long diameter direction from both end portions of the wide portion 70a in the extension direction. A width of the narrow portion 70b in the direction of the swing axis A is smaller than a width of the wide portion 70a in the direction of the swing axis A. When a viewpoint is changed, it can be said that the rib part 70 has a shape obtained by chipping the four corners of a rectangular parallelepiped in an L shape when viewed from the height direction thereof. Each chipped portion K of the four corners of the rib part 70 is adjacent to an end surface of the wide portion 70a and a side surface of the narrow portion 70b. Each chipped portion K is provided with a solidified portion 71. That is, the solidified portion 71 is provided adjacent to both end portions of the rib part 70 in the extension direction. The solidified portion 71 is a portion obtained by solidifying a liquid or gel-like adhesive in a state in which the surface of the adhesive has been curved by surface tension. In the present embodiment, the adhesive includes a photocurable adhesive (an example of photocurable resin). When the solidified portion 71 is formed, an adhesive is firstly coated on a portion corresponding to each chipped portion K in the aforementioned opposite side surface 41b of the vibration mirror part 41. Next, light with a predetermined wavelength, such as ultraviolet light, is irradiated into the coated adhesive, so that the adhesive is solidified, resulting in the formation of the solidified portion 71. In the present embodiment, the rib part 70 and the solidified portion 71 are made of materials different from each other.

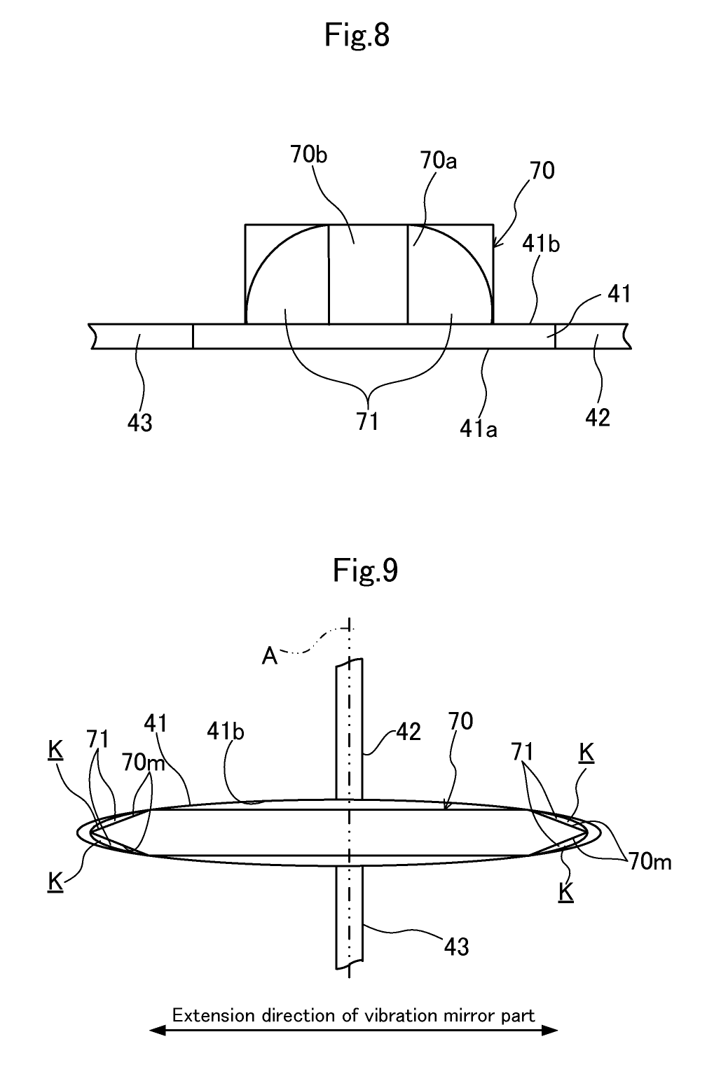

As illustrated in FIG. 7 and FIG. 8, the surface of the solidified portion 71 has a curved surface shape to be convex outward the solidified portion 71 by surface tension. Furthermore, the surface of the solidified portion 71 has a curved surface shape such that a height is reduced from an inner side in a radial direction toward an outer side in the radial direction of the vibration mirror part 41. A maximum height of the solidified portion 71 coincides with a height of the rib part 70.

As described above, in the aforementioned embodiment, since the rib part 70 is formed on the opposite side surface 41b of the reflective surface 41a side in the vibration mirror part 41, it is possible to suppress the vibration mirror part from being deformed by repetitive stress at the time of vibration, which acts on the vibration mirror part 41.

Furthermore, since the solidified portion 71 is formed at a position adjacent to both end portions of the aforementioned rib part 70 in the extension direction, the amount of a substance constituting the solidified portion 71 is adjusted, so that it is possible to easily adjust a resonance frequency of a vibration system.

Furthermore, the aforementioned solidified portion 71 is obtained by solidifying a liquid or gel-like adhesive in a state in which the surface has a curved surface shape by surface tension. Consequently, it is possible to reduce air resistance acting on the vibration mirror part 41 at the time of vibration of the vibration mirror part 41. That is, when the solidified portion 71 is not provided, airflow generated by the vibration of the vibration mirror part 41 is rapidly bent or separated around edges of both end portions of the rib part 70 in the extension direction, so that air resistance acting on the vibration mirror part 41 becomes large. On the other hand, when the solidified portion 71 is provided at a position adjacent to both end portions of the rib part 70 in the extension direction, the airflow generated by the vibration of the vibration mirror part 41 smoothly flows along the curved surface shape of the surface of the solidified portion 71. Thus, the airflow in the vicinity of the vibration mirror part 41 is not rapidly bent or separated around the edges of both end portions of the rib part 70. Thus, the air resistance acting on the vibration mirror part 41 is reduced, so that it is possible to stabilize the behavior (amplitude) of the vibration mirror part 41.

Furthermore, in the aforementioned embodiment, the solidified portion 71 is formed by solidifying an adhesive at the chipped portions K formed at the four corners of the rib part 70. In detail, the rib part 70 includes the wide portion 70a and the pair of narrow portions 70b connected to both end portions of the wide portion 70a in the extension direction, and the solidified portion 71 is formed by solidifying an adhesive at the chipped portions K adjacent to the end surface of the wide portion 70a and the side surfaces of the narrow portions 70b.

According to this configuration, as compared with the case in which the rib part 70 has a simple rectangular parallelepiped shape (see FIG. 11), it is possible to maximize the length of the rib part 70 in the extension direction. Thus, it is possible to suppress rapid bending or separation of airflow generated around the vibration mirror part 41 while ensuring the rigidity of the vibration mirror part 41.

Furthermore, since the substance constituting the aforementioned solidified portion 71 is configured by a photocurable adhesive, it is possible to solidify resin at room temperature as compared with the case in which thermosetting resin or solder is used as the material constituting the solidified portion 71, so that it is possible to prevent the rib part 70 and the vibration mirror part 41 from thermally deformed by heat transfer from the solidified portion 71.

Furthermore, the opened part of the housing body 51 accommodating the optical deflector 40 is closed by the lid 52. That is, an accommodating space in the housing body 51 accommodating the optical deflector 40 and an external space of the housing body 51 are partitioned by the lid 52. In this way, it is possible to further reduce air resistance at the time of vibration of the vibration mirror part 41. That is, when there is no lid 52, air in the housing body 51 is extruded out of the housing body 51 from the opened part by the vibration mirror part 41, and instead, air out of the housing body 51 is introduced from the opened part. Therefore, air density around the vibration mirror part 41 gently changes according to the passage of time. On the other hand, in the aforementioned embodiment, since the circulation of air through the opened part of the housing body 51 is blocked by the lid 52, it is possible to suppress a change in the density of the air around the vibration mirror part 41. Furthermore, it is possible to stabilize the behavior (amplitude) of the vibration mirror part 41.

As described above, the aforementioned optical deflector 40 is used and thus the behavior of the vibration mirror part 41 is stabilized, so that it is possible to improve the scanning accuracy of light by the optical scanning device 30. Furthermore, it is possible to improve the quality of a printed image by the laser printer 1.

### Embodiment 2

FIG. 9 illustrates an embodiment 2. In the present embodiment, the shape of both end portions of the rib part 70 in the extension direction is different from that of the aforementioned embodiment 1. The same reference numerals are used to designate the same elements as those of FIG. 6 and a detailed description thereof will be omitted.

That is, in the present embodiment, both end portions of the rib part 70 have a symmetrical isosceles triangle shape while interposing a long axis of the vibration mirror part 41 therebetween when viewed from a height direction thereof. When a viewpoint is changed, the rib part 70 has a shape obtained by chamfering and chipping the four corners of the rectangular parallelepiped. Each chamfered surface 70m has a planar shape in the present embodiment. Each chipped portion K at the four corners of the rib part 70 is formed such that a width of the rib part 70 in the direction of the aforementioned swing axis A becomes narrow from the center side of the rib part 70 in the extension direction toward both end sides thereof.

According to this configuration, as compared with the case in which the rib part 70 has a simple rectangular parallelepiped shape (see FIG. 11), it is possible to maximize the length of the rib part 70 in the extension direction. Thus, it is possible to suppress rapid bending or separation of airflow generated around the vibration mirror part 41 while ensuring the rigidity of the vibration mirror part 41. Furthermore, the width of the rib part 70 in the direction of the aforementioned swing axis A becomes gradually narrow from the center side of the rib part 70 in the extension direction toward both end sides thereof, so that it is possible to enhance the strength of the rib part 70 as compared with the case in which the rib part 70 is configured by the wide portion 70a and the narrow portions 70b similarly to the aforementioned embodiment 1. Thus, it is possible to more reliably suppress deformation of the vibration mirror part 41 at the time of vibration.

<<Modification>>

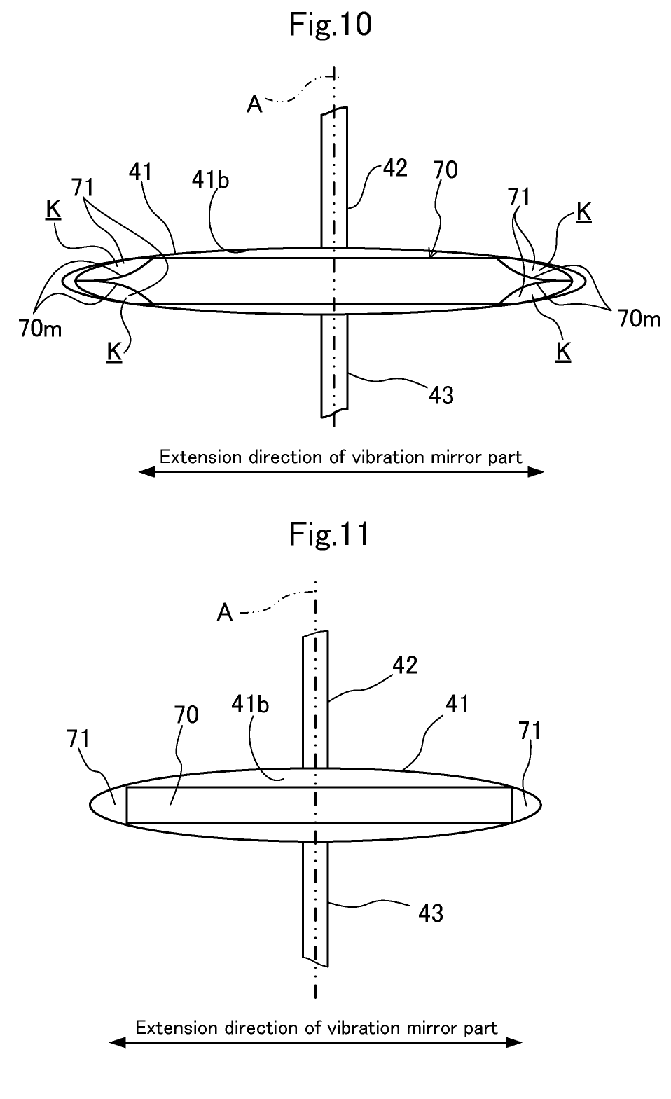

FIG. 10 illustrates a modification of the embodiment 2. In this modification, the shape of both end portions of the rib part 70 in the extension direction is different from that of the aforementioned embodiment 2. It is noted that the same reference numerals are used to designate the same elements as those of FIG. 9 and a detailed description thereof will be omitted.

That is, in the present embodiment, each chamfered surface 70m of the four corners of the rib part 70 is formed in a curved surface shape recessed inward the rib part 70. In this way, as compared with the embodiment 2, it is possible to increase a formation area of the solidified portion 71 in which the surface forms a curved surface. Thus, it is possible to more reliably suppress bending or separation of airflow generated around the end portion of the rib part 70 at the time of vibration of the vibration mirror part 41.

### OTHER EMBODIMENTS

In the aforementioned each embodiment, the rib part 70 and the solidified portion 71 are made of materials different from each other; however, the present invention is not limited thereto. The rib part 70 and the solidified portion 71 may also be made of the same material. In this way, since the linear expansion coefficients of the rib part 70 and the solidified portion 71 are equal to each other, it is possible to maintain an adhesive property of a boundary portion between the rib part 70 and the solidified portion 71 regardless of a temperature change in the vibration mirror part 41. Thus, it is possible to prevent airflow from being disturbed at the boundary portion.

In the aforementioned each embodiment, photocurable resin is employed as a liquid or gel-like substance before the solidified portion 71 is solidified; however, the present invention is not limited thereto. For example, thermosetting resin or solder may also be employed.

Furthermore, in the aforementioned each embodiment, the vibration mirror part 41 extends in the direction perpendicular to the swing axis A; however, the present invention is not limited thereto. The vibration mirror part 41 may also extend in a direction inclined with respect to the swing axis A. That is, it is sufficient if the vibration mirror part 41 extends in a direction crossing the laser printer 1.

Furthermore, in the aforementioned each embodiment, the example in which the optical deflector 40 has been applied to the laser printer 1 has been described; however, the present invention is not limited thereto. For example, the optical deflector 40 may also be applied to a copy machine, a multifunctional peripheral, a projector and the like.

Furthermore, the technology of the present disclosure is not limited to the aforementioned embodiments 1 to 3 and includes configurations obtained by appropriately combining these embodiments 1 to 3 with one another.

As described above, the technology of the present disclosure is useful in an optical deflector and an image forming apparatus including the optical deflector.

What is claimed is:

1. An optical deflector comprising:
a vibration mirror part having a reflective surface for reflecting light;
a torsion bar part that supports the vibration mirror part;
a driving part that torsionally vibrates the vibration mirror part around the torsion bar part, wherein
the vibration mirror part extends in a direction crossing a swing axis of the vibration mirror part, and
a rib part extending along an extension direction of the vibration mirror part is formed on an opposite side surface of a side of the reflective surface in the vibration mirror part,
the optical deflector further comprising;
a solidified portion provided adjacent to both end portions of the rib part in an extension direction and obtained by solidifying a liquid or gel-like substance in a state in which a surface of the liquid or gel-like substance has a curved surface shape by surface tension.

2. The optical deflector of claim 1, wherein a chipped portion is formed at both end portions of the rib part in the extension direction, and the solidified portion is formed by solidifying the substance at the chipped portion.

3. The optical deflector of claim 2, wherein the chipped portion is formed such that a width of the rib part in a direction of the swing axis becomes narrow from a center side of the rib part in the extension direction toward both end sides thereof.

4. The optical deflector of claim 1, wherein a substance constituting the solidified portion includes photocurable resin.

5. An image forming apparatus comprising the optical deflector of claim 1.
